(19) United States
(12) Patent Application Publication
(10) Pub. No.: US 2016/0109914 A1
(43) Pub. Date: Apr. 21, 2016

(54) WEARABLE DEVICE WITHOUT A POWER BUTTON

(71) Applicant: Google Inc., Mountain View, CA (US)

(72) Inventor: Jeremy Evan Blum, San Francisco, CA (US)

(21) Appl. No.: 14/516,001

(22) Filed: Oct. 16, 2014

(51) Int. Cl. G06F 1/26; G06F 9/44

(52) U.S. Cl. CPC G06F 1/26; G06F 9/4401

(57) ABSTRACT

An example of a wearable device, such as a head mounted device, without a power button while still implementing the functions of a typical power button is provided. A sensor may be positioned adjacent to a hinge so as to detect the orientation thereof, such as detecting whether the hinge is in the opened or closed position. The sensor may output a signal that indicates the detected orientation of the hinge to a microcontroller. The microcontroller may then output a signal to a power management integrated circuit that alters the current state of the device. For instance, the signal sent to the power management integrated circuit may power on or off the head mounted device, or place the device in a sleep state. In this regard, the head mounted device is capable of switching between states without the use of a typical power button.

### BACKGROUND

Wearable electronic devices come in various forms including smart watches or head mounted devices. These wearable devices have typically been viewed as another type of electronic device that keeps people connected to the world around them, much like their smart phone. In addition, while these wearable devices are becoming more complex, they also have a limited surface area to fit all of the features of larger computing devices. As a result, input mechanisms may be small and positioned within close range of one another. A user may inadvertently press a wrong input button or multiple buttons, particularly if the user cannot see the input button when the device is being worn such as with a head-mounted device.

### SUMMARY

A head mounted device that automatically switches between states without a power button is disclosed. By automatically switching between states, the head mounted device acts more like a fashionable accessory that has the capabilities of an electronic device. The various states of the head mounted device may include the powered on state, powered off state, sleep state, etc. The head mounted device may detect the orientation and state of a hinge on the head mounted device, and based on the detected orientation of the hinge the head mounted device may automatically switch between states. For instance, a sensor may detect the orientation of the hinge and then output a signal, such as in the form of voltage, to a microcontroller indicating the detected orientation. The microcontroller may then forward a signal to a Power Management Integrated Circuit (“PMIC”), which causes the PMIC to switch the current state of the device based on the signal sent by the microcontroller. Accordingly, the state of the device switches based on the orientation of the hinge, thereby eliminating confusion by the user in using the power button to switch between the various states of the head mounted device. In addition, this also causes the head mounted device to function much like a typical pair of prescription glasses, because the user does not need to click a button in order for the head mounted device to operate; rather, the user simply opens the hinge of the device.

Aspects of the disclosure provide a computer implemented system. The system includes a sensor configured to detect an orientation of a device; one or more processors in communication with the sensor, the one or more processors configured to: receive a first input from the sensor; determine, based on the first input, the orientation of the device; based on the determined orientation, output a corresponding signal; and provide, via a safety circuit, interference for the outputted signal when a characteristic of the outputted signal deviates from a predetermined allowable characteristic; and a power management circuit in communication with the one or more processors, the power management circuit adapted to receive the corresponding signal from the one or more processors and deliver a predetermined amount of power to the device based on the corresponding signal.

As another example, the device includes a hinge, the orientation of the device being that the hinge is in an opened or closed position. In another example, the predetermined allowable characteristic includes at least one of a duration of the signal and a frequency of the signal. As another example, the outputted signal corresponds to a signal that indicates a command to change a state of the device. In another example, the one or more processors are further configured to initiate a reboot of the device when the device is unresponsive. In that example, the reboot is initiated when a user enters an input into the device. As another example, the input includes the user opening and closing the hinge a predetermined amount of times. In another example, the reboot is initiated when a component fails to receive a signal from a timing component at a predetermined interval. In a further example, the reboot is initiated when a user plugs a cable into a port of the device. In another example, the reboot occurs by the one or more processors sending an override signal to the power management circuit.

Another aspect of the disclosure discloses a computer implemented method. The method includes receiving a first input from the sensor; determining, using one or more processors and based on the first input, the orientation of the device; based on the determined orientation, outputting, using the one or more processors, a corresponding signal; providing, via a safety circuit, interference for the outputted signal when a characteristic of the outputted signal deviates from a predetermined allowable characteristic; and delivering a predetermined amount of power to the device based on the corresponding signal. In another example, the orientation of the device being that the hinge is in an opened or closed position. As another example, the predetermined allowable characteristic includes at least one of a duration of the signal and a frequency of the signal. As another example, the outputted signal corresponds to a signal that indicates a command to change a state of the device. In a further example, the method includes initiating a reboot of the device when the device is unresponsive. In that example, the reboot is initiated when a user enters an input into the device. In another example, the input includes the user opening and closing the hinge a predetermined amount of times. In another example, the reboot is initiated when a component fails to receive a signal from a timing component at a predetermined interval. As another example, the reboot is initiated when a user plugs a cable into a port of the device.

Another aspect of the disclosure discloses a wearable device. By way of example, the wearable device includes a sensor positioned on an arm of the device, the sensor being configured to detect a characteristic of the device; and one or more processors in communication with the sensor, the one or more processors configured to: receive a first input from the sensor; determine, based on the first input, the characteristic of the device, the characteristic indicating whether the device is in use or not; based on the determined characteristic, output a corresponding signal; and provide, via a safety circuit, interference for the transmission of the outputted signal when the outputted signal deviates from a predetermined allowable characteristic; a power management circuit in communication with the one or more processors, the power management circuit adapted to receive the corresponding signal from the one or more processors and deliver a predetermined amount of power to the device based on the corresponding signal.

### BRIEF DESCRIPTION OF THE DRAWINGS

FIG. 1 is a top view of an example wearable device including a hinge mechanism in accordance with aspects of the disclosure.

FIG. 2 is an oblique view of a housing of the wearable device in accordance with aspects of the disclosure.

FIG. 3 illustrates an example wearable device with the hinge in the closed position in accordance with aspects of the disclosure.

FIG. 4 illustrates a sensor of the wearable device in accordance with aspects of the disclosure.

FIG. 5 is an example functional diagram of operating the wearable device in accordance with aspects of the disclosure.

FIG. 6 illustrates a graph where no signal is output by a microcontroller of the wearable device in accordance with aspects of the disclosure.

FIG. 7 illustrates a graph where a signal is output by the microcontroller in accordance with aspects of the disclosure.

FIG. 8 illustrates a graph of an inadvertent output by the microcontroller in accordance with aspects of the disclosure.

FIGS. 9A-B are examples of a safety circuit interfering with an outputted signal and not interfering with an outputted signal in accordance with aspects of the disclosure.

### DETAILED DESCRIPTION

The technology generally pertains to removing a power button on a wearable device and using another mechanism of the wearable device to perform the typical functions of the power button. For example, where the wearable device is a head-mounted display, the power button functions may be implemented within a hinge. In other examples, the wearable electronic device may be a smart watch, wristband, etc. In the example of the head-mounted display, when the hinge is in the opened position, the head mounted device may automatically turn on. When the hinge is in the closed position, the device may automatically turn off. Alternatively, the closed hinge may simply place the device in a sleep state as opposed to a powered off state. The hinge of the device may be monitored by a microcontroller that continues to operate in essentially all states, including the powered off state. In this regard, the microcontroller may operate at very low power when the device is powered off to preserve battery life. When the microcontroller detects movement of the hinge, such as the hinge moving from the closed position to the opened position, the microcontroller may activate the head mounted device.

The microcontroller controls the state of the head mounted device by managing the PMIC. For instance, the microcontroller may send an electrical pulse to the PMIC that indicates to the PMIC to change the state of the head mounted device. In addition, the microcontroller and PMIC may be configured to withstand mistaken pulses, such as from electrostatic discharge or other events. Finally, in the unlikely event that the head mounted device is unresponsive (e.g., freezes) in any of the plurality of states mentioned above, various techniques may be implemented to reboot the device.

The head mounted device may include a central portion that runs along a portion of a user's face. First and second side arms may extend from opposite ends of the central portion on first and second sides of the user's head. The first side arm may include a housing configured to house various electrical components, circuitry, and a battery in order to operate the head mounted device. In addition, the first side arm may include a hinge configured to transition the head mounted device between a closed position and an opened position.

The hinge mechanism may be configured to act as a de facto power button by causing the head mounted device to enter one of a plurality of states. For instance, the head mounted device may have an active state when in use, a powered off state when turned off, and a sleep state when idle. It should be understood that the head mounted device may also have a dead state in the situation where the battery is completely drained, but the hinge would not cause the head mounted device to enter the dead state.

In order for the hinge to operate as a de facto power button, the head mounted device may employ a sensor and microcontroller that detects the positioning of the hinge and reacts thereto. As one example, the sensor may be a hall effect sensor that detects magnetic flux density from a magnet positioned in the hinge. The hall effect sensor may then relay information it detects to the microcontroller. One or more sensors, such as a mechanical switch, an infrared sensor, etc., could also serve as a means for detecting the positioning of the hinge and providing position information to the microcontroller. The microcontroller, in cooperation with the PMIC and the Application Processor, control a power state of the head mounted device based on the sensed position information. As an example, when the hinge moves from the opened position to the closed position, the microcontroller, via the sensor, may detect the closed positioning of the hinge and cause the head mounted device to enter a sleep state.

The microcontroller communicates with the PMIC to switch the head mounted device between power states (e.g., on and off). It may also communicate directly with the Application Processor to tell the system to wake up or enter a sleep state. For example, the microcontroller may send electrical pulses to the PMIC, thereby changing the state of the head mounted device. In this regard, the PMIC and/or microcontroller and/or Application Processor may maintain a “state machine” that tracks the current state of the device. The state machine may define the various states of the device, such as the active state, sleep state, etc. The microcontroller may send a pulse chain from the microcontroller to the PMIC to initiate a transition between the various states as defined by the state machine. The pulse chain may be a series of electrical pulses sent from the microcontroller to the PMIC.

The first side arm may also include a safety circuit that mediates the electrical pulses sent from the microcontroller to the PMIC. For example, as discussed above state changes are associated with particular electrical pulses, such as pulse chains. In the event an electrical pulse is inadvertently or mistakenly released by the microcontroller, the safety circuit may prevent such electrical pulses from ever reaching the PMIC by determining that the electrical pulse does not meet the required frequency and duration. For example, if the safety circuit receives an electrical pulse that lasts 2 milliseconds, then the safety circuit may disregard the electrical pulse and not forward it to the PMIC. This is because 2 milliseconds of an electrical pulse is too short a time to have been done purposely. Alternatively, if the safety circuit detects an electrical pulse train that lasts 7 milliseconds with an appropriate frequency, then the safety circuit may trigger a control pulse to the PMIC, because that is long enough to signify that the message was intentionally sent.

Finally, in the case that the head mounted device becomes unresponsive (e.g., freezes), the head mounted device may employ multiple functions to reboot the device. As one example, a timer mechanism may be employed that determines whether the device is frozen or not. For instance, the microcontroller may periodically receive signals, such as a ping, that indicates the device is working properly. The ping may come from, as one example, the Application Processor. If the microcontroller fails to receive the ping at the predetermined time interval, then the microcontroller may send an override signal to the PMIC to reboot the device. As an alternative, a mechanical function may be employed as well in order to reboot the device. As one example, the user may open and close the hinge three subsequent times and cause the microcontroller to send the override signal to the PMIC to reboot the device. As another alternative, simply plugging the head mounted device into a charging cable and initiating a charging session may cause the microcontroller to initiate the reboot.

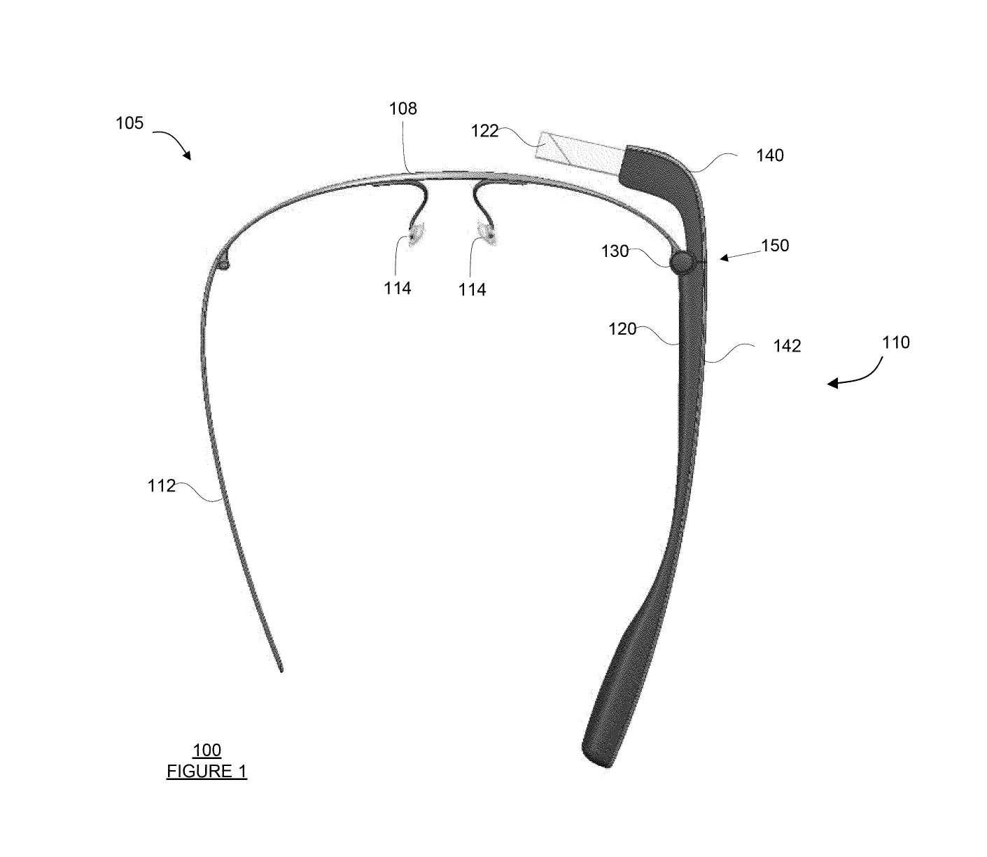

FIG. 1 illustrates one example of the hinge mechanism on the head mounted device as described above. As shown in example 100 of FIG. 1, the head mounted device 105 forms an asymmetrical shape. The head mounted device 105 contains a central portion 108 that extends in two opposing directions toward a first side arm 110 and a second side arm 112. The central portion 108 also includes nose pieces 114 extending therefrom. The first and second side arms 110 and 112 and the nose pieces 114 are configured to secure the head mounted device 105 to a head of the user, for example, by extending over a first and second ears of the user and resting on a nose of the user.

The head mounted device may be comprised of a solid structure such as plastic, metal, etc., and also combinations thereof. Other materials and configurations are also possible.

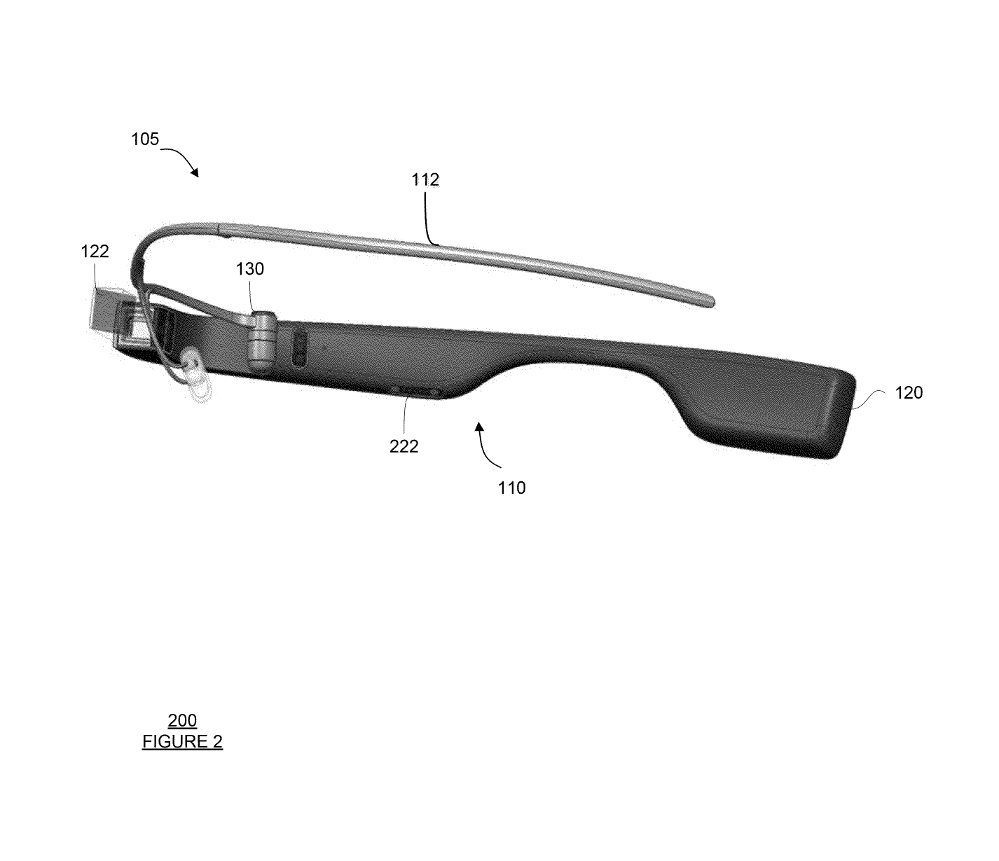

As illustrated in FIGS. 1 and 2, the first side arm 110 of the head mounted device 105 includes outer housing 120 to protect internal components therein. The outer housing 120 may include, for example, electrical circuitry, wiring, processors, etc. which may be used to operate the device. The first side arm may be larger and elongated as compared to the second side arm so as to accommodate the components contained in the first side arm, thus resulting in the asymmetric shape of the overall architecture of the head mounted device. In addition, as shown on example 200 of FIG. 2, the first side arm 110 has an input/output port 222 adapted to receive cables or other types of electronic devices. For example, the input/output port 222 may receive charging cables that charge the head mounted device and/or data cables that allow for the transfer of electrical or audio data signals between the head mounted device and another computing device, such as an audio player or a personal computer.

Display 122 may be formed of any material that can suitably display a projected image or graphic. The display 122 may also be sufficiently transparent so as to allow the user to see through the display. In addition, the internal components of the first side arm may be operatively coupled to display 122. Additional components to operate the device may be housed in an elbow portion 140, which is coupled to display 122 and secures the display in place, as shown in FIG. 1. The internal components of the first side arm and the elbow portion may operate the head mounted device; thus causing an image, graphic, menu options and other forms of text, etc. to show on display 122.

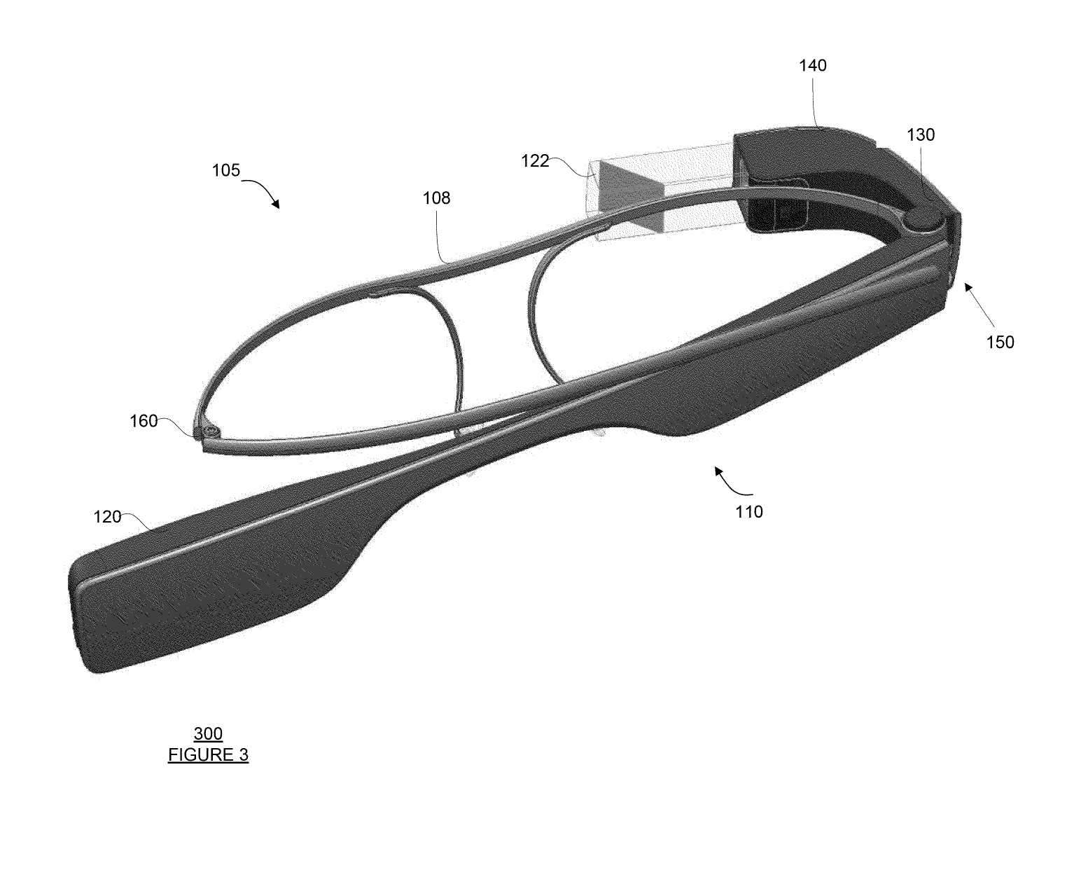

As shown in FIG. 3, head mounted device 105 includes two hinge mechanisms that allow a user to fold the device for easier storage and transportation. A first hinge 150 is located on the first side arm 110 and a second hinge 160 is located on the second side arm 112. The first and second hinges 150 and 160 allow for the user to easily open and close the head mounted device. The first hinge 150 of the first side arm 110 is positioned on a first end of the first side arm 110 that is adjacent to a first end of the central portion 108. The first hinge 150 is positioned where a button 130, central portion 108, first side arm 110, and the elbow portion 140 come together. Alternative locations of the hinge are also possible. For example, the hinge may be placed by itself on the first side arm, without being directly adjacent to the button 130, elbow portion 140, etc. The second hinge 160 on the second side arm 112 is also positioned on a first end of the second side arm that is adjacent to a second side of the central portion 108, for example, wherein the second side of the central portion 108 opposes the first side of the central portion 108.

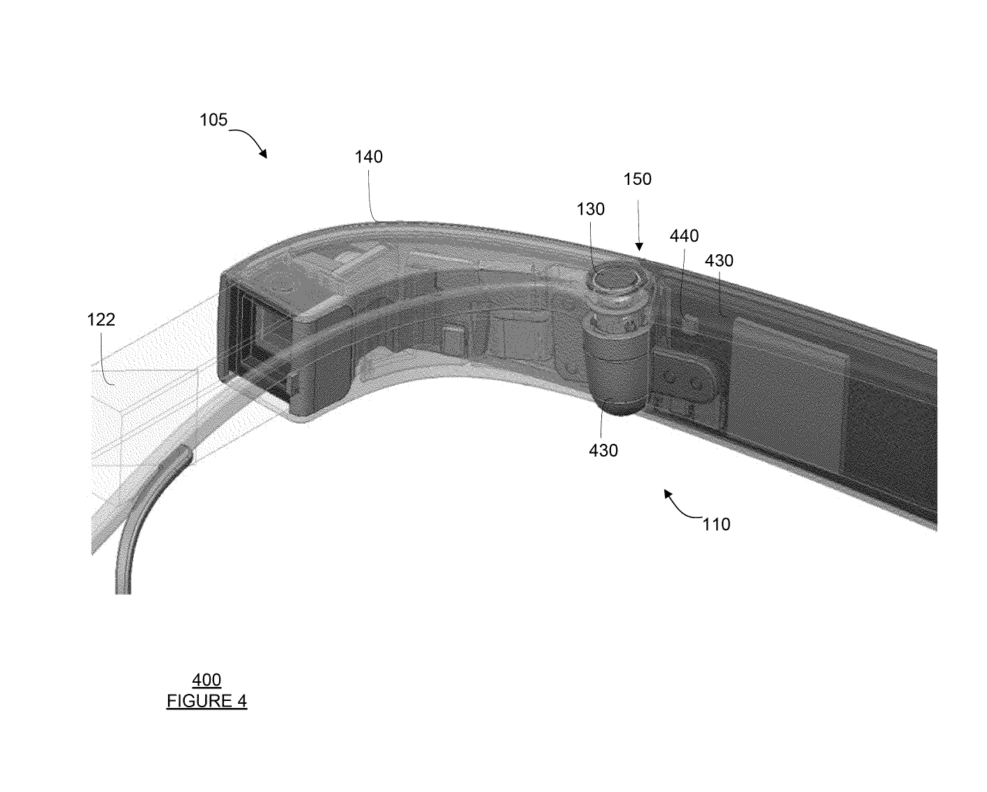

As shown in FIG. 4, a sensor 440 positioned on the first side arm 110 may detect the orientation of the first hinge 150. For example, the sensor 440 may be positioned adjacent to the first hinge 150 so as to be able to detect whether the first hinge is in an opened or a closed position.

The sensor 440 may be a hall effect sensor that can detect magnetic flux density from the first hinge 150. The magnetic flux density may emanate from a magnet that is mounted in or on button 130. In other examples, the magnet may be strategically placed in other areas of the hinge that permit sensor 440 to detect changing magnetic flux densities. For example, the magnet may be placed inside button housing 430 as its own component. Likewise, the sensor 440 may be positioned on other portions of the wearable device, such as on the central portion, on the hinge itself, or elsewhere.

As another example, the sensor 440 may be a mechanical switch or an infrared sensor that is capable of detecting the orientation of the first hinge 150. For instance, a mechanical switch sensor can determine the positioning of the hinge once the switch is actuated as a result of the hinge moving into the opened or closed position. An infrared sensor may detect the motion, reflection, or radiation that is emitted from the hinge or a component of the hinge when the hinge is moved from the opened or closed position.

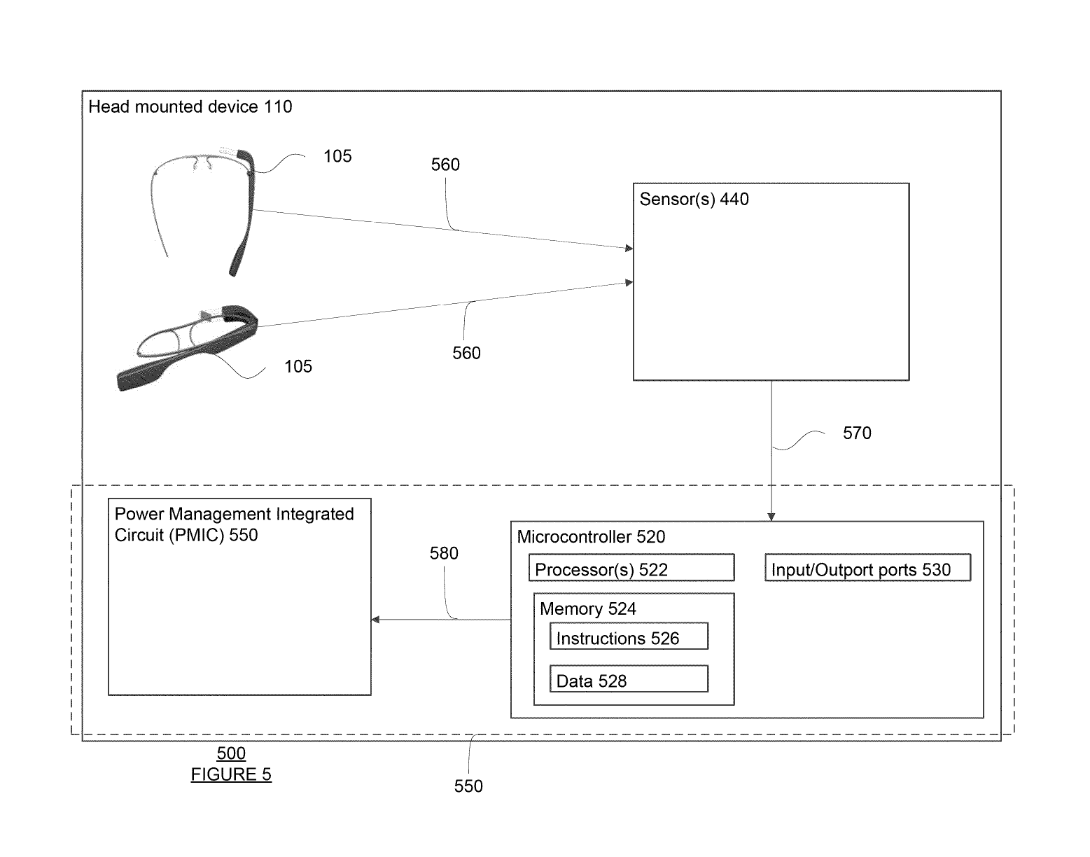

Example 500 of FIG. 5 illustrates the sensor 440 detecting the orientation of the hinge of the head mounted device 105. In this scenario, arrows 560 of FIG. 5 may represent the detected orientation of the first hinge of the head mounted device.

The sensor may transmit the detected orientation of the hinge to a microcontroller via a signal. For instance, as shown in example 500 of FIG. 5, after the sensor detects the respective signals from the head mounted device 105, the sensor relays the detected state to microcontroller 520. The sensor 440 may output and relay the detected state to the microcontroller 520 by way of scaled analog voltage or digitally coded information, as represented by arrow 570. In this regard, the value associated with the output from sensor 440 may correspond to a particular value that indicates the detected orientation of the first hinge of the head mounted device. Thus, the output from the sensor may be a first value when the detected state of the hinge is in the closed position, and a second value when the detected state of the hinge is in the opened position.

The microcontroller 520 that receives the output value from sensor 440 may include, for example, at least one processor, memory, data, instructions, and input/output ports. The processor(s) 522 can be any conventional processor, such as a commercially available microprocessor. Alternatively, the processor can be a dedicated component such as an ASIC or other hardware-based processor. In this regard, the technology herein is not limited to a microcontroller, but any processing component, including only a processor, that is capable of performing the functions described herein. According to another example, the head mounted device may include a processor, memory, data, and instructions separate from the microcontroller to perform either the same tasks as the microcontroller or other tasks.

The memory 524 can include data that can be retrieved, manipulated or stored by the processor 522. The memory 524 can be of any non-transitory type capable of storing information accessible by the processor 522, such as a non-volatile memory store, memory card, ROM, RAM, DVD, CD-ROM, write-capable, and read-only memories.

The instructions 526 can be any set of instructions to be executed directly, such as machine code, or indirectly, such as scripts, by the one or more processors. In that regard, the terms “instructions,” “application,” “steps” and “programs” can be used interchangeably herein. The instructions can be stored in object code format for direct processing by the processor, or in any other computing device language including scripts or collections of independent source code modules that are interpreted on demand or compiled in advance. Functions, methods and routines of the instructions are explained in more detail below.

Data 528 can be retrieved, stored or modified by the one or more processors 522 in accordance with the instructions 526. For instance, although the subject matter described herein is not limited by any particular data structure, the data can be stored in computer registers, in a relational database as a table having many different fields and records, or XML documents. The data can also be formatted in any computing device-readable format such as, but not limited to, binary values, ASCII or Unicode. Moreover, the data can comprise any information sufficient to identify the relevant information, such as numbers, descriptive text, proprietary codes, pointers, references to data stored in other memories such as at other network locations, or information that is used by a function to calculate the relevant data. Data 528 may include information with respect to a “state machine,” which tracks the current state of the device and the various states that the device can enter. For example, the states may be the sleep state, active state, or powered off state. In addition, information of the various states of the device may be managed by either the microcontroller and/or, as discussed further below, the Power Management Integrated Circuit (“PMIC”).

The microcontroller may perform a function based on the value received from the sensor. For example, based on the received value from the sensor, which indicates the orientation of the first hinge of the head mounted device, the microcontroller may send a signal to the PMIC or the Application Processor. The Application Processor may operate similarly to processor 522 as described above with respect to the microcontroller 520. The PMIC may be responsible for managing the power requirements for the head mounted device. The PMIC may include the components and operate like a typical PMIC, such as containing a battery charging system, converters for powering components such as the processors and memory, etc. Example 500 of FIG. 5 illustrates the microcontroller sending a signal to the PMIC represented by arrow 580. The signal sent from the microcontroller to the PMIC may be, as one example, in the form of an electrical pulse.

The signal sent from the microcontroller to the PMIC may vary in frequency and duration. For instance, the duration of the electrical pulse chain may be 50 milliseconds long and the frequency may be 40 repetitions within that timeframe. As discussed in more detail below, a pulse chain within a particular frequency and duration range may be required to trigger the PMIC. It should be understood that other forms of signals, such as analog or digital signals, may be sent from the microcontroller to the PMIC in addition to electrical pulse chains.

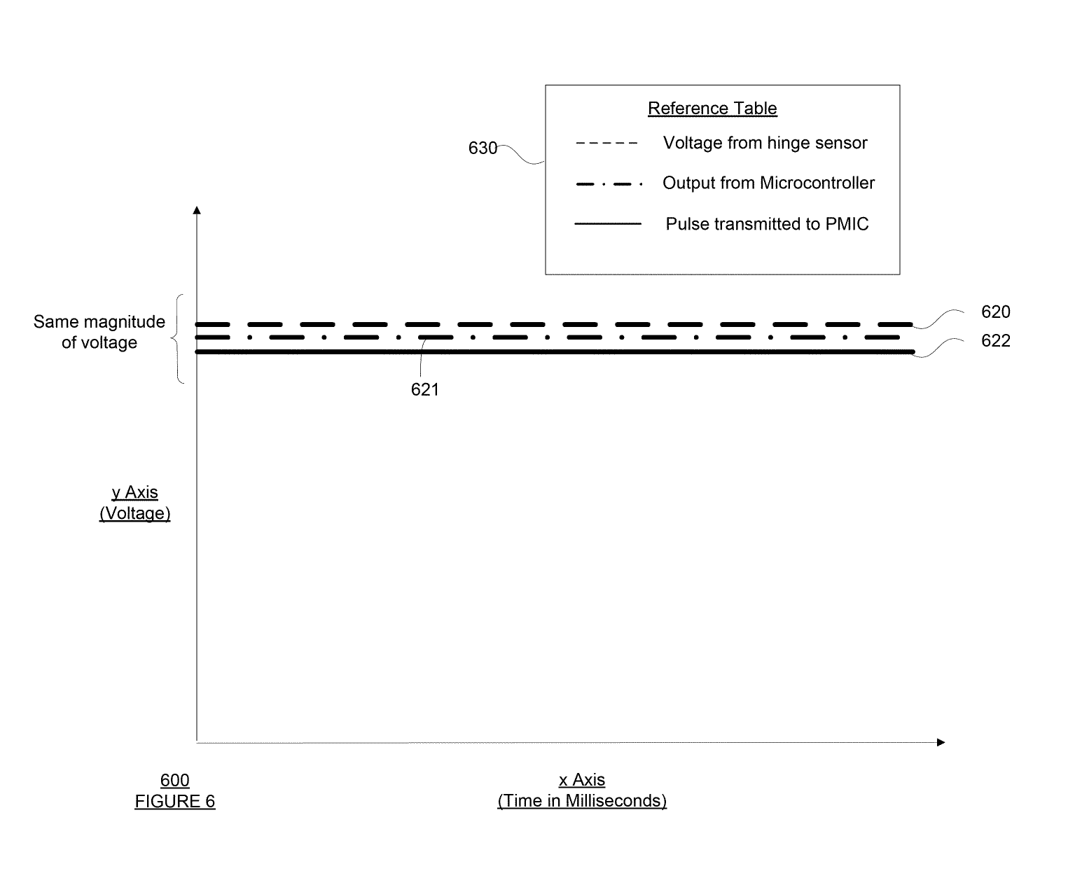

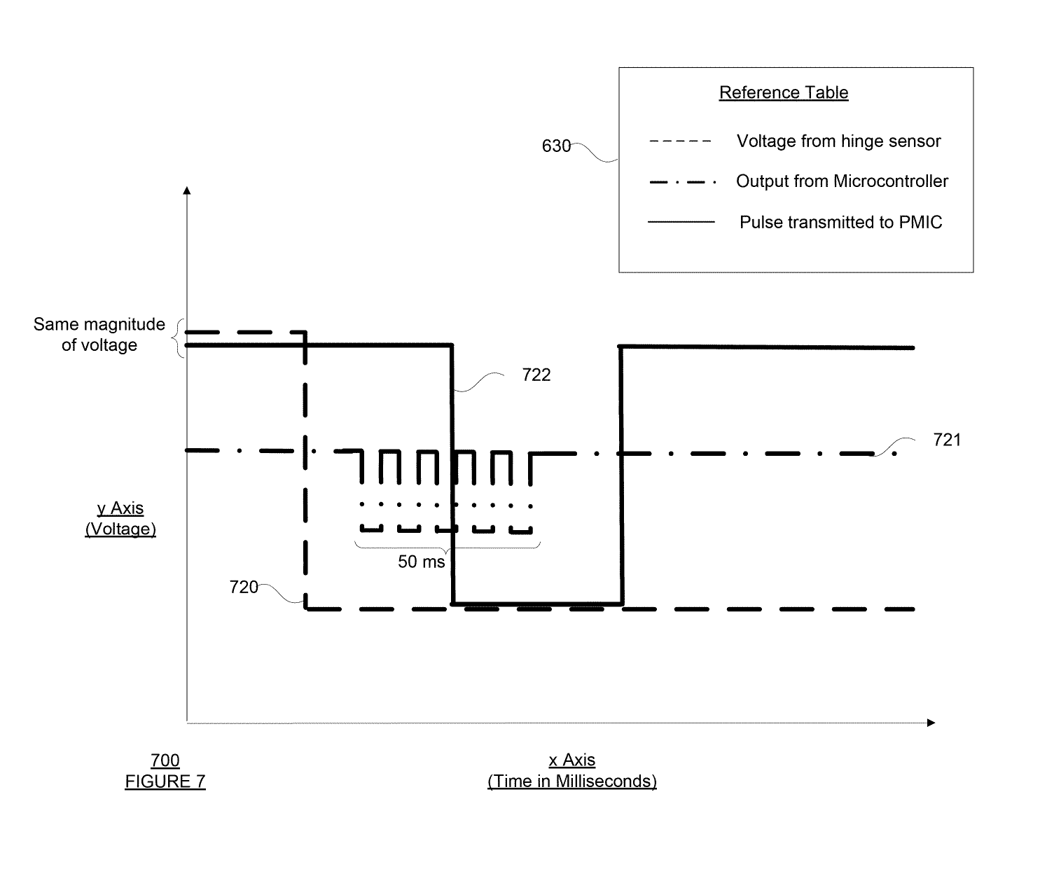

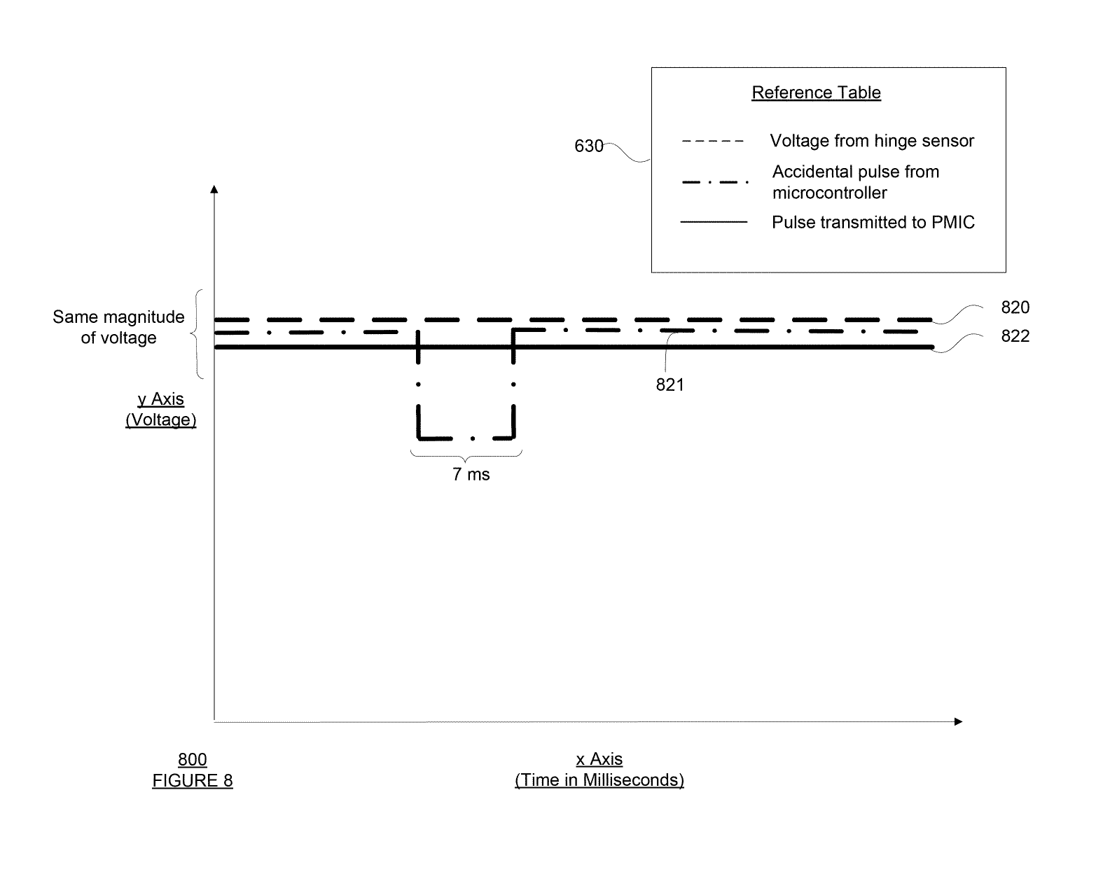

The signal sent from the microcontroller to the PMIC may correspond to a certain value that causes the PMIC to perform a particular function. Alternatively, when no signal is sent from the microcontroller then no actions are performed by the PMIC. Example 600 of FIG. 6 is a graph illustrating no action by the sensor, microcontroller, and the PMIC. As illustrated in Reference Table 630 of FIG. 6, the dashed line represents the voltage from the hinge sensor, the dashed-dotted line represents output from the microcontroller, and the solid line represents a pulse transmitted to the PMIC. For example, the output from the microcontroller may be an output to a power control circuit, and the power control circuit may output the corresponding pulse to the PMIC. The voltage from the PMIC to power the device depends on the pulse sent from the microcontroller to the PMIC. Thus, in FIG. 6 because there is no pulse signal sent from the microcontroller to the PMIC, the PMIC also does not react. It should be understood that the level of voltage that the three lines represent in FIG. 6 may be the same. Therefore, the respective lines in FIG. 6 being placed at slightly different voltage levels is simply for illustrative purposes only. This also applies to FIGS. 7 and 8 as described below.

The signal sent from the microcontroller may be based on the output sent from the sensor to the microcontroller, which indicates the detected orientation of the hinge. The microcontroller may send a signal to the PMIC that causes the PMIC to react based on the orientation of the hinge. For instance, if the first hinge moves from the opened position to the closed position, then the pulse chain sent from the microcontroller to the PMIC may cause the PMIC to place the head mounted device in either a powered-off state or in sleep mode. In this scenario, placing the device in sleep mode may be more beneficial to a user so that when the user wants to use the head mounted device again, the head mounted device can boot up quickly. As another example, when the first hinge moves from the closed position to the opened position, the head mounted device may turn on. In this regard, if the head mounted device was fully powered off then the head mounted device would be turned on. On the other hand, if the head mounted device was simply in sleep mode while in the closed position, then the device may quickly activate from sleep mode.

The graph in FIG. 7 provides one example 700 of the various actions of the head mounted device when a different orientation of the first hinge is detected. For instance, in FIG. 7 the sensor sends voltage 720 to the microcontroller, as represented by the temporary plateau of signal 720. The voltage 720 may indicate, for example, that the first hinge has been either opened or closed. In response to receiving the voltage, the microcontroller may send a pulse chain to the PMIC, as represented by the rectangular pulse chain 721. The solid line 722 represents the PMIC receiving the signal sent from the microcontroller. It should be understood that the level of voltage of lines 720 and 722 in FIG. 7 should be the same, but are at slightly different levels for illustrative purposes only. Moreover, and as described in more detail below, the PMIC may not always receive the signal from the microcontroller because the signal may be interrupted by a safety or power control circuit. By receiving the signal from the microcontroller, the PMIC may perform a predetermined action. For example, the PMIC may control the power of the device by distributing voltage to the various components thereof, which may alter the state of the device. For instance, by the PMIC controlling the voltage the PMIC may place the device in sleep mode or powered-off mode, or it may activate the device such as by turning it on. As discussed above, the action performed by the PMIC depends on the detected orientation of the hinge from the sensor.

The signal sent from the microcontroller to the PMIC may also have a debounce time as one means to prevent inadvertent or mistaken pulses from the microcontroller. For instance, as illustrated in example 700 of FIG. 7, the duration of the pulse chain 721 spans 50 milliseconds in time, representing that the hinge was placed, as one example, in the closed position. The microcontroller may be programmed such that the output signal must last for a predetermined period of time in order to register as a legitimate signal. If the output signal does not last for the predetermined amount of time, the signal may be disregarded as illegitimate. For example, if the debounce time was only 2 milliseconds, then the PMIC may disregard that signal as being illegitimate because of its short time span. Example 800 of FIG. 8 illustrates an inadvertent output by the microcontroller, as represented by signal 821, in which case the PMIC would not react. The signal from the microcontroller in FIG. 8 was inadvertent because the voltage from the hinge sensor, represented by dashed line 820, stays stagnant, which indicates that the microcontroller acted on its own. Thus, the signal from the microcontroller is inadvertent. Furthermore, the signal from the microcontroller lasted for only milliseconds, which is insufficient to cause the PMIC to react. In addition, the pulse transmitted to the PMIC, as represented by solid line 822, also stays stagnant, which indicates that the PMIC ignored the inadvertent signal from the microcontroller. In order for the PMIC to react, a pulse chain of longer duration is required, such as the pulse chain 721 in FIG. 7.

A safety or power control circuit may also be employed to prevent potential inadvertent or mistaken signals to be sent from the microcontroller to the PMIC. The safety circuit, for example, may prevent the inadvertent or mistaken signal sent from the microcontroller from reaching the PMIC, which may cause undesired actions by the PMIC, such as powering on or off the head mounted device. The safety circuit may determine what signals to prevent based on the particular frequency and duration of the signal. For instance, if the signal only lasts milliseconds long and/or has a frequency that has 4 repetitions within that particular time frame, then the safety circuit may prevent the signal from reaching the PMIC. In this scenario, the safety circuit may determine that 6 milliseconds is too short a time period and 4 repetitions is too low a frequency for the signal to have been intentional. As another example, if the safety circuit determines that the signal strength of the signal is weaker than it should be, then it may also prevent that signal from reaching the PMIC. It should be understood that the safety circuit may be designed to determine what frequencies and durations are permitted and not permitted; thus, which frequencies can reach the PMIC and which cannot.

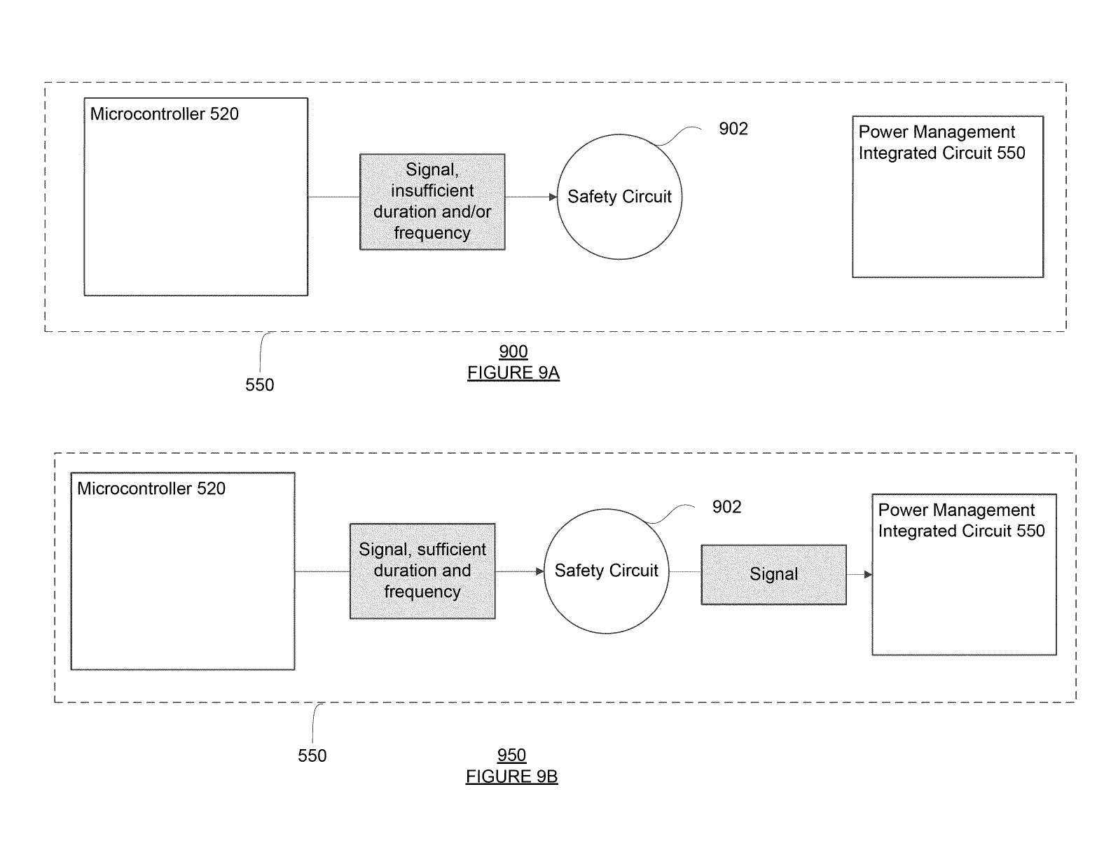

Examples 900 and 950 of FIGS. 9A-B illustrate an example implementation of the safety circuit. For instance, in example 900 of FIG. 9A, the safety circuit 902 receives a signal, such as a digital or analog signal, which contains information of a frequency and/or duration that is insufficient. For example, a signal that contains a pulse chain with a duration of 20 milliseconds and a frequency of 6 repetitions within that time frame may be insufficient. In this scenario, once the signal reaches the safety circuit 902 the safety circuit 902 does not forward a signal to the PMIC 550 because the safety circuit determined that the frequency may have been illegitimate. This protects against any possible microcontroller malfunctions accidentally turning the device on or off when not desired.

Example 950 of FIG. 9B shows the microcontroller 520 sending another signal to the safety circuit 902. Here, the signal contains a frequency and duration that is sufficient. For example, a signal that contains a pulse chain with a duration of 70 milliseconds and a frequency of 70 repetitions within that time frame may be sufficient. Thus, the safety circuit 902 forwards the signal to the PMIC because the safety circuit has determined that the signal is legitimate, at least according to the safety circuit's parameters of which frequencies and durations to allow and which frequencies and durations not to allow.

The components described above which control the various states of the head mounted device may remain active so as to always be able to detect the movement of the first hinge. For example, even if the head mounted device is powered off, the sensor, microcontroller, PMIC, etc. may still operate at very low power levels in order to detect the first hinge from moving to an opened position, and then performing the respective operations necessary to power on the device. To achieve this low power level, for example, the sensor may operate a low duty cycle—only querying hinge state once per second. The amount of power required to keep the various components in operation for this particular purpose is low enough to allow the head mounted device to last for months without affecting the battery level of the head mounted device. The various components used to control the state of the device may also be in operation at all other times, such as during the active state, sleep state, etc.

The head mounted device may employ various methods to reboot the head mounted device such as in situations where the device becomes unresponsive or freezes. As one example, a timer mechanism may be implemented which indicates whether or not the head mounted device is still working properly. For instance, the timer may operate by the microcontroller periodically receiving a ping from a separate component, such as a processor. In this scenario, when the microcontroller stops receiving the ping as part of the regular interval, the microcontroller may determine that the head mounted device has frozen and is unresponsive. As a result, the microcontroller may send an override signal to the PMIC which reboots the device.

As another example of an override system, a mechanical function may be employed. For instance, the mechanical function may require the user to open and close the first hinge for a predetermined number of times, such as three times. When this occurs and is detected by the sensor, the sensor may forward the action to the microcontroller, which in turn may send a signal to the PMIC to reboot the head mounted device. Alternative mechanical overrides may be implemented as well, such as the user performing an input action on the device. For instance, the user may click on a button on the device, such as a camera button, or perform an operation on a touch pad. In either case, the input by the user may be unique so as to trigger the reboot only when the user needs to.

In another example, the user may cause the microcontroller to send an override signal to the PMIC by initiating a charging session for the head mounted device. For instance, the user may plug the head mounted device via the input/output ports into a cable that is plugged into a power outlet. In this scenario, when the head mounted device begins to charge, the microcontroller may send a signal to the PMIC which causes the head mounted device to reboot if it detects that the device is in an unresponsive state. It should be understood that other override mechanisms are also possible.

According to another example, the technology described above may not be limited to a head mounted device, but rather any wearable electronic device, such as a smart watch, wristband, etc. In this regard, the sensor on another wearable electronic device may not detect the orientation of the hinge, but rather other parameters that indicate the device is currently in use by the user. For instance, for a smart watch the sensor may detect the presence of a pulse on the user or the heat emitted from the body of the user. Accordingly, depending on the type of wearable device and the characteristic detected by the sensor, the technology may then continue as described above, such as by the sensor outputting a signal to the microcontroller, and the microcontroller outputting a signal to the PMIC.

The subject matter described herein is advantageous in that it provides a computing device without a power button, while still maintaining the functions and performance of a power button. In this regard, a number of buttons on the wearable device may be reduced, thereby improving the aesthetics of the device while also limiting the input functions a user would have to learn and memorize. In addition, by the wearable device being able to automatically switch between states, the device acts more like an accessory to the user as opposed to an electronic device that requires user input in order to operate.

The head mounted device functions like a regular pair of glasses, such as prescription glasses, in that the device works as soon as the user puts the head mounted device on their head. This is possible because of the automatic detection of the orientation of the hinge, and the automatic response thereto by the head mounted device.

In the example where the wearable electronic device is a watch, the watch may automatically switch between states when the sensor detects an orientation of the device that indicates the watch is being worn or not being worn. For example, a clasp on a band of the watch may be repositioned between an open position and a closed position, where each position triggers a different state of the watch. Such clasp may include a hinge, for example, similar to that described above with respect to the head-mounted device.

The system described above also reduces confusion for the user in terms of the various states that the head mounted device can be in, such as a sleep state, active state, powered-off state, etc. In addition, the head mounted device is able to prevent potential inadvertent or mistaken signals from the microcontroller to the PMIC by implementing various techniques, such as the requirement for debounce time as described above and the implementation of the safety circuit.

As these and other variations and combinations of the features discussed above can be utilized without departing from the subject matter as defined by the claims, the foregoing description of embodiments should be taken by way of illustration rather than by way of limitation of the subject matter as defined by the claims. It will also be understood that the provision of the examples described herein (as well as clauses phrased as “such as,” “e.g.”, “including” and the like) should not be interpreted as limiting the claimed subject matter to the specific examples; rather, the examples are intended to illustrate only some of many possible aspects.

1. A system comprising:
a sensor configured to detect an orientation of a device;
one or more processors in communication with the sensor, the one or more processors configured to:
receive a first input from the sensor;
determine, based on the first input, the orientation of the device;
based on the determined orientation, output a corresponding signal; and
provide, via a safety circuit, interference for the outputted signal when a characteristic of the outputted signal deviates from a predetermined allowable characteristic; and
a power management circuit in communication with the one or more processors, the power management circuit adapted to receive the corresponding signal from the one or more processors and deliver a predetermined amount of power to the device based on the corresponding signal.

2. The system of claim 1, wherein the device includes a hinge, the orientation of the device being that the hinge is in an opened or closed position.

3. The system of claim 1, wherein the predetermined allowable characteristic includes at least one of a duration of the signal and a frequency of the signal.

4. The system of claim 1, wherein the outputted signal corresponds to a signal that indicates a command to change a state of the device.

5. The system of claim 1, wherein the one or more processors are further configured to initiate a reboot of the device when the device is unresponsive.

6. The system of claim 5, wherein the reboot is initiated when a user enters an input into the device.

7. The system of claim 6, wherein the input includes the user opening and closing the hinge a predetermined amount of times.

8. The system of claim 5, wherein the reboot is initiated when a component fails to receive a signal from a timing component at a predetermined interval.

9. The system of claim 5, wherein the reboot is initiated when a user plugs a cable into a port of the device.

10. The system of claim 5, wherein the reboot occurs by the one or more processors sending an override signal to the power management circuit.

11. A method comprising:
receiving a first input from the sensor;
determining, using one or more processors and based on the first input, the orientation of the device;
based on the determined orientation, outputting, using the one or more processors, a corresponding signal;
providing, via a safety circuit, interference for the outputted signal when a characteristic of the outputted signal deviates from a predetermined allowable characteristic; and
delivering a predetermined amount of power to the device based on the corresponding signal.

12. The method of claim 11, wherein the device includes a hinge, the orientation of the device being that the hinge is in an opened or closed position.

13. The method of claim 11, wherein the predetermined allowable characteristic includes at least one of a duration of the signal and a frequency of the signal.

14. The method of claim 11, wherein the outputted signal corresponds to a signal that indicates a command to change a state of the device.

15. The method of claim 11, further comprising initiating a reboot of the device when the device is unresponsive.

16. The method of claim 15, wherein the reboot is initiated when a user enters an input into the device.

17. The method of claim 16, wherein the input includes the user opening and closing the hinge a predetermined amount of times.

18. The method of claim 15, wherein the reboot is initiated when a component fails to receive a signal from a timing component at a predetermined interval.

19. The method of claim 15, wherein the reboot is initiated when a user plugs a cable into a port of the device.

20. A wearable device, comprising:
a sensor positioned on an arm of the device, the sensor being configured to detect a characteristic of the device;
one or more processors in communication with the sensor, the one or more processors configured to:
receive a first input from the sensor;
determine, based on the first input, the characteristic of the device, the characteristic indicating whether the device is in use or not;
based on the determined characteristic, output a corresponding signal; and
provide, via a safety circuit, interference for the transmission of the outputted signal when the outputted signal deviates from a predetermined allowable characteristic;
a power management circuit in communication with the one or more processors, the power management circuit adapted to receive the corresponding signal from the one or more processors and deliver a predetermined amount of power to the device based on the corresponding signal.
